(19) United States
(12) Patent Application Publication
(10) Pub. No.: US 2003/0010817 A1
(43) Pub. Date: Jan. 16, 2003

(54) Method of forming a thermoformed corrugated container and a corrugated container formed thereby

(76) Inventors: John E. Lingle, Brookfield, WI (US); David B. Stucker, Hartford, WI (US); Jeffrey S. Covelli, Mukwanago, WI (US)

Correspondence Address: BOYLE, FREDRICKSON, NEWHOLM,, STEIN & GRATZ, SC, SUITE 1030, 250 EAST WISCONSIN AVENUE, MILWAUKEE, WI, 53202, US

(21) Appl. No.: 10/189,807

(22) Filed: Jul. 3, 2002

Related U.S. Application Data
(60) Provisional application No. 60/303,488, filed on Jul. 6, 2001.

(51) Int. Cl. B65D 1/34; B29C 51/14

(52) U.S. Cl. 229/406; 229/407; 264/293; 264/294; 264/320

(57) ABSTRACT

The present invention is a method for forming a corrugated container having a double wall construction. A blank is formed of a pair of corrugated layers sandwiched between and adhered to adjacent flat layers and having a sufficient moisture content to enable the blank to be formed. The blank can include printed indicia, thermoresistant coatings, release coatings, and other coatings applied to the blank to enhance the utility of the container formed from the blank. The blank is then inserted into a thermoforming machine in which a pair of heated dies compress the blank into the desired container shape.

### CROSS-REFERENCE TO RELATED APPLICATIONS

This application claims priority under 35 U.S.C. §119(e) from U.S. Provisional Patent Application Serial No. 60/303,488, filed on Jul. 6, 2001, and incorporated herein in its entirety.

### BACKGROUND OF THE INVENTION

1. Field of the Invention

The present invention relates to a thermoformed corrugated container and more specifically to a thermoformed container having a double-wall, or dual-fluted construction.

2. Background of the Related Art

A number of food items and other articles are commonly packaged in a tray-like container for sale to the consumer. For example, at a grocery store, certain assorted food items, such as fruits, vegetables, cookies, candies, and so forth, may be packaged in a tray-like container having an open top that is covered with a lid formed of a clear plastic film. Such tray-like containers are commonly made from a molded or thermoformed plastic. To thermoform the plastic into a container having the desired shape, initially a flat sheet of the plastic material is heated above a transition temperature at which the plastic material softens. By heating the plastic material to this temperature, the plastic loses its tendency to attempt to return to its original shape or its “memory” of its original shape. Thus, when the plastic material subsequently moves to the forming tooling at a forming station of a machine, is formed and is cooled, the plastic material will remain in its formed shape as long as the material is not reheated above the transition temperature.

In the prior art, other types of material have also been used in thermoforming processes to form packaging materials. For example, a compressed fiberboard material has been used in a thermoforming process to create packaging containers. However, the amount and weight of the fiberboard needed results in a container that is very expensive and very heavy, such that most food packaging containers are not suitable for being manufactured with this type of material. Also, due to the heat transfer properties of the fiberboard, containers formed of this material are not capable of adequately insulating or heating any food products placed within containers formed of the fiberboard.

Corrugated paperboard is also a commonly used packaging material. This type of material is normally formed of a corrugated or fluted paperboard layer having a pair of flat paperboard layers attached to each side. Single layer corrugated paperboard, having a single corrugated layer placed between a pair of flat outer layers, has previously been used in thermoforming processes. However, this type of corrugated paperboard is normally not a thermoformable material as it has not been possible to thermoform a single layer corrugated container that adequately retains its shape. This is because the single wall corrugated material previously used in thermoforming processes does not have the requisite properties, namely, a transition temperature above which the paperboard can be heated or a sufficient moisture content, to form a useful thermoformed container. As a result, a thermoformed paperboard container will not retain its shape after cooling in the same manner as a plastic thermoformed container. In other words, any conventional thermoformed paperboard container will deform or “relax” and change its dimensions over time in an attempt to revert to its original or “remembered” form as it cools. As a result, corrugated containers are instead fabricated by first producing a large, flat, corrugated sheet or blank, which is then cut, scored, folded, and glued in order to form the container. A common cardboard box is a typical example.

However, corrugated paperboard material, provides a number of unique advantages when utilized as a material for forming food packaging. Most importantly, the conventional construction of a fluted layer positioned between a pair of flat end layers used in most corrugated paperboards provides an insulating barrier between heated food within the container and cooler outside air, thus keeping the heated food hot for an extended period of time. Therefore, it is desirable to develop a corrugated paperboard structure that can be thermoformed in a conventional manner into a container that retains the benefits of conventional corrugated containers.

### SUMMARY OF THE INVENTION

The present invention is a corrugated paperboard material formed to have a double-wall construction that is capable of being thermoformed in a conventional manner into a container that retains its shape for a greatly extended period of time when compared with conventional thermo formed corrugated containers. The corrugated material of the present invention is formed with a central flat paperboard layer positioned between a pair of fluted paperboard layers. The fluted paperboard layers have different flute sizes such that the tips of each flute of each layer are offset from one another along the length of the material. The material also includes at least one additional flat paperboard layer secured to one of the corrugated layer opposite the central flat paperboard layer. This provides an exterior surface of the container on which printed indicia, or selected coatings can be placed. The material may also include a second flat end paperboard layer secured to the opposite corrugated layer that forms an interior surface for the container which may also have printed indicia or selected coatings placed upon it. Further, the material has a moisture content high enough to enable the material to be formed without damaging the material.

One of the novel aspects of the present invention is that the flute size for each of the corrugated layers is greatly reduced from that previously known in the manufacture of double-walled corrugated material such that, when the material is thermoformed, the corrugated material retains its shape for a greatly extended period of time.

Further, the method of forming the corrugated material of the present invention prevents the imprinted indicia or coatings placed on one or both outer surfaces of the corrugated material from becoming damaged during the forming process, such that the container formed from the corrugated material can be used for its intended purpose of holding and cooking food products without detrimentally effecting the food products held within the container.

Various other objects and advantages of the present invention will be made apparent from the following detailed description taken together with the drawing figures.

### BRIEF DESCRIPTION OF THE DRAWINGS

The drawings illustrate the best mode currently contemplated of practicing the present invention.

In the drawings:

FIG. 1 is an isometric view of a thermoformed corrugated container constructed according to the present invention;

FIG. 2 is a top plan view of the container of FIG. 1;

FIG. 3 is a side view of the container of FIG. 1;

FIG. 4 is a cross-sectional view along line 4-4 of FIG. 2;

FIG. 5 is a cross-sectional view along line 5-5 of FIG. 4;

FIG. 6 is an isometric view of a second embodiment of a container constructed according to the present invention;

FIG. 7 is an isometric view of a thermoforming machine used to form the container of FIG. 1;

FIG. 8 is a first side elevation view of the machine of FIG. 7;

FIG. 9 is a second side elevation view of the machine of FIG. 7;

FIG. 10 is a partially broken away isometric view of the lower mold and clamp of the machine of FIG. 7;

FIG. 11 is a partially broken away isometric view of the upper mold of the machine of FIG. 7;

FIG. 12 is an isometric view of another embodiment of a container constructed according to the present invention; and

FIG. 13 is a top plan view of a blank used to form the container of FIG. 12.

### DETAILED DESCRIPTION OF THE INVENTION

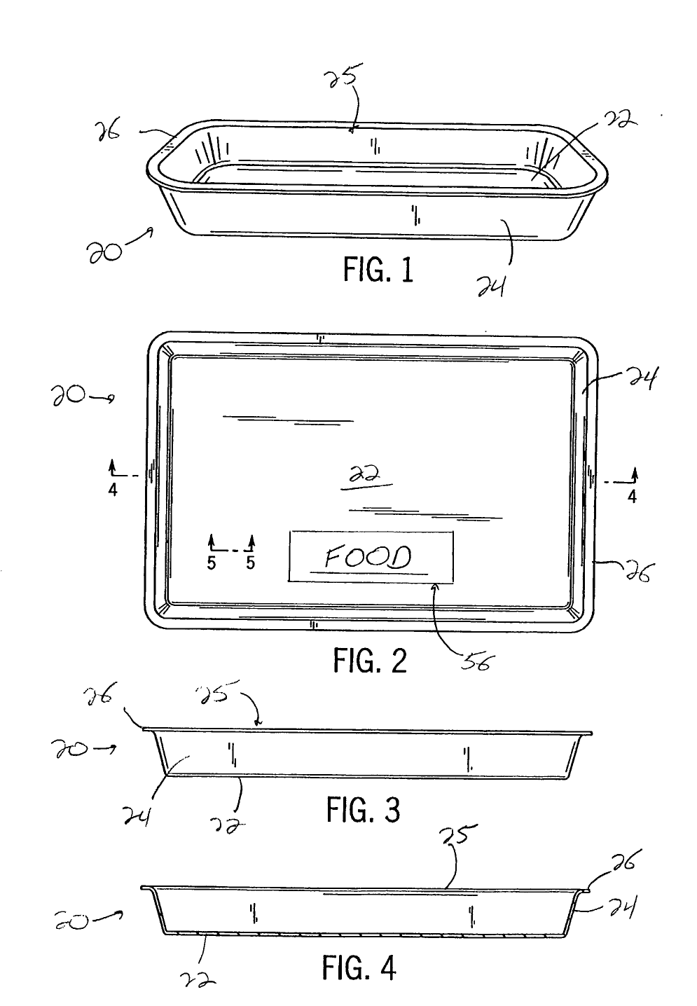

With regard to the drawing figures in which like reference numerals designate like parts throughout the disclosure, a container formed according to the present invention is indicated generally at 20 in FIGS. 1-4. The container 20 includes a base 22, a peripherally extending wall 24 integrally formed with and extending upwardly from the base 22 and defines an open end 25 opposite the base 22, and a lip 26 integrally formed with and extending outwardly from the wall 24 opposite the base 22 in a directly generally parallel to the base 22. The container 20 can be generally rectangular in shape as shown in FIGS. 1-4, but can also have any desired configuration based on the particular use the container 20 is made for or particular items to be placed or held in the container 20, such as the circular container 28 illustrated in FIG. 6 or the sectional container 110 including the partitions 112 and downwardly curving lip 114 shown in FIG. 12.

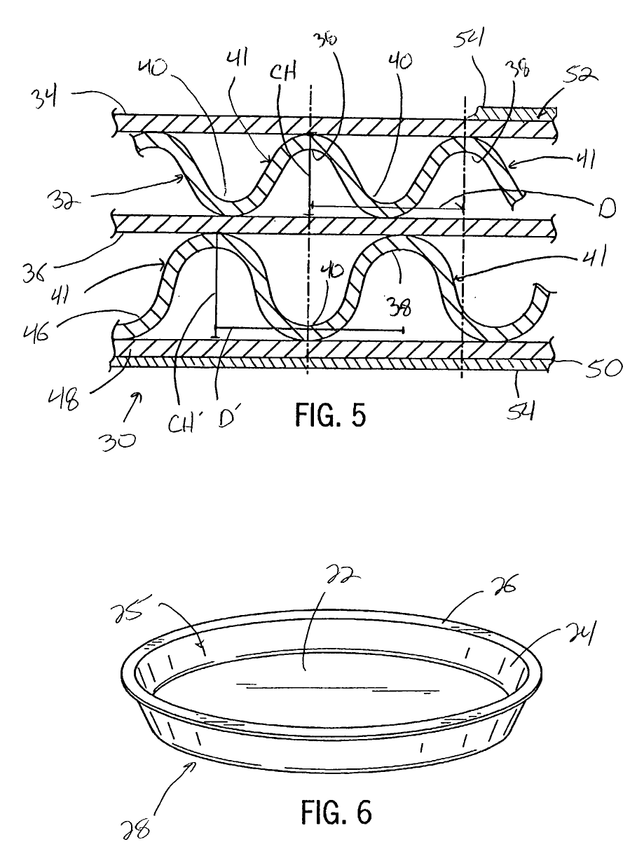

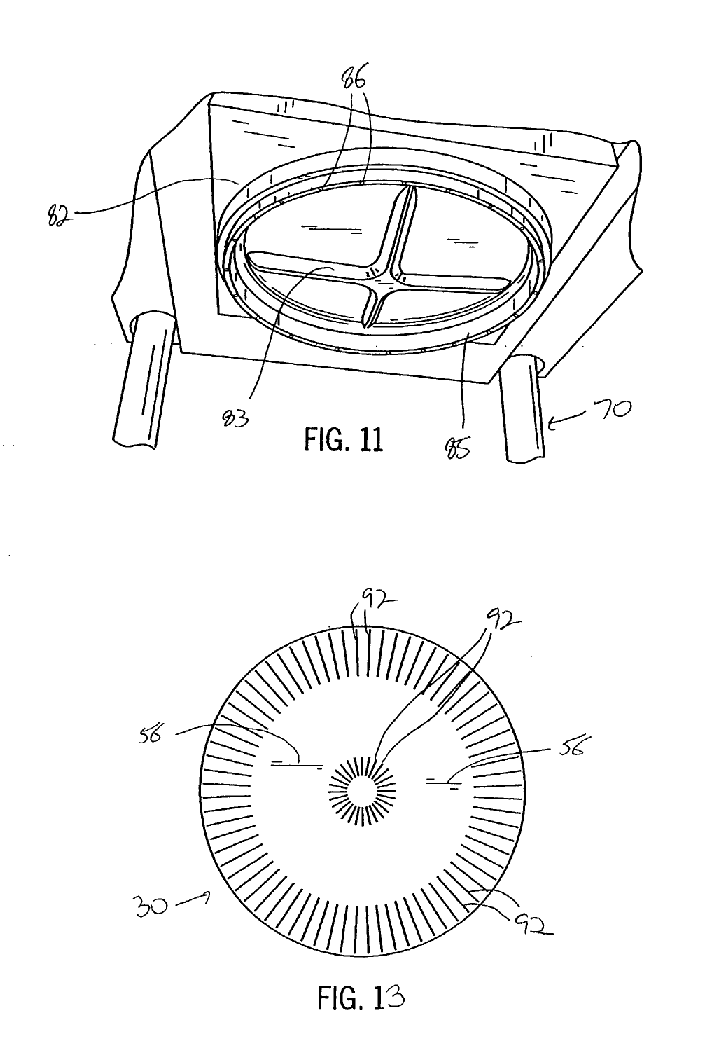

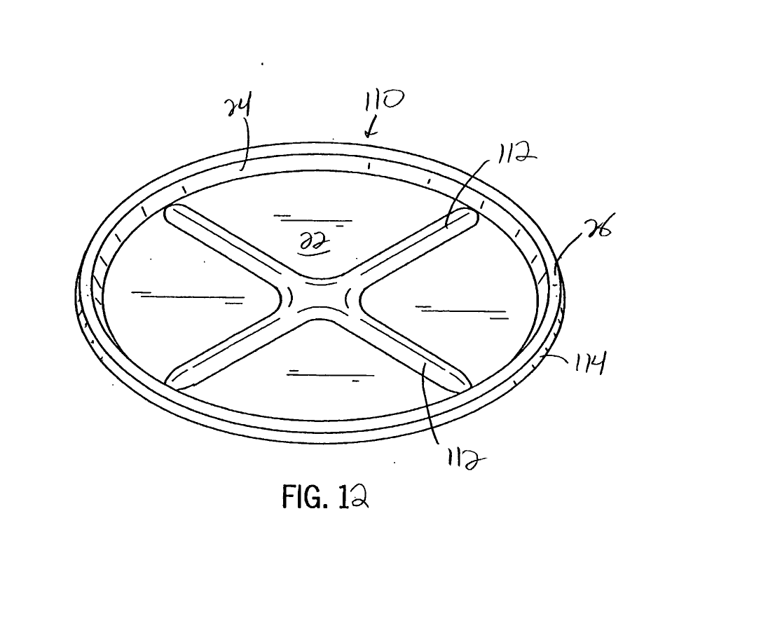

The containers 20 and 28 are each formed from a blank 30 of corrugated material that is best shown in FIGS. 5 and 13. To form the corrugated paperboard blank 30, initially three layers of sheet paper stock are adhered to one another in a configuration in which a first corrugated layer of paper 32 is sandwiched between first and second flat paper liners 34 and 36. The middle layer of paper 32 is corrugated by forming in it a regular pattern of alternating ridges or tips 38 and grooves 40. The ridges 38 and grooves 40, referred to in the industry as “flutes” 41, are then glued to the one surface of each of the first and second flat paper liners 34 and 36, respectively. In comparison to a solid board (not shown) of the same thickness, the corrugated paper board blank 30 uses much less material, which typically makes the corrugated blank 30 much less costly to manufacture, and is much stronger structurally.

In the present invention, the blank 30 is preferably formed of a corrugated paperboard of a type known as “double-wall.” To make the blank 30 a double-wall corrugated paperboard, in addition to the three paperboard layers 32, 34 and 36 described above, the double-wall blank 30 further includes the second corrugated or fluted layer 46 positioned on the second flat liner 36 opposite the first corrugated layer 32, and a third flat liner layer 48 positioned against the second fluted layer 46 opposite the second paper liner 36. The double-wall blank 30 can alternatively be formed by adhering two single wall corrugated layers each having a single corrugated layer and two flat outer layers to one another. Also, the first corrugated layer 32 and second corrugated layer 46 can be positioned transverse or perpendicular to one another in the double-wall construction of the blank 30.

The paper used in forming each of the layers 32, 34, 36, 46 and 48 of the blank 30 can be any type of sheet material suitable for use in paperboard construction, but has a caliper height range of 0.002 to 0.034 inches, and weighs from 10 lb. to 90 lbs. per 1000 square feet of the paper. Types of paper which are particularly useful include, but are not limited to, containerboard paper grades, such as recycled Kraft liner paperboard, semi-chemical medium paperboard and recycled medium paperboard, Kraft liner paperboard, white top paperboard, and bleached linerboard. Various combinations of any of these paper types materials can also be used depending on the end use application and strength desired for the container 20. In addition, other non-traditional containerboard grades can be incorporated into the blank 30, such as bleached converting paper, bleached multiwall paper, bleached bag paper, and cup stock paper grades. In oven-able containers 20, a process such as a bleaching fiber process can be used on the paper forming the layers 32, 34, 36, 46 and 48 to eliminate contaminates that may cause unwanted odors in the food and container 20 during and after cooking. Additional heat resistance enhancements known in the art may also be incorporated in the paper during the manufacturing process for the paper, as well as titanium oxide which may be used to prevent browning of the paper in high heat applications (over 400°) of the container 20.

To secure the layers 32, 34, 36, 46 and 48 to one another and form the blank 30, the flutes 41 of each of the first and second corrugated layers 32 and 46 are adhered to the surfaces of the flat liner layers 34, 36 and 48, as illustrated in FIG. 5. While any suitable adhesive known in the art can be used to adhere the layers of the blank 30 to one another, a particularly preferred adhesive is the adhesive disclosed in applicant's U.S. Pat. No. 6,139,938, which is herein incorporated by reference. Also, the adhesive can be applied to the layers 32, 34, 36, 46 and 48 in any order and in any conventional manner, such as that disclosed in the '938 patent. Further, in certain embodiments for the container 20, the flat liner 48 is optional, meaning that in some containers 20 two flat outer surfaces 50 and 52 defined by the layers 34 and 48 are desired for the blank 30, which requires the use of all five layers 32, 34, 36, 46 and 48 to form the blank 30, but in some containers 20 one flat outer surface 50 and one fluted surface (not shown) may be desired, in which case one of the outermost layers 32 or 48 is omitted.

In the corrugated industry, the term “caliper height” refers to the overall thickness of the particular paperboard material blank 30. The term “chordal height” refers to just the height of the flutes 41, designated and shown as CH and CH′ in FIG. 5. The overall thickness of the blank 30, that is, the caliper height, is of course dependent on the thickness of the individual flat paper layers 34, 36 and 48 and also on the chordal height of the corrugated layers 32 and 46. In the corrugated industry, the chordal height of the flutes 41 is commonly categorized into grades designated as A-G, with A being the largest and G being the smallest. The following is a table illustrating the relative flutes per foot and chordal heights for the different flute grades:

| Category | Flues/Foot | Chordal Height (in.) |
|---|---|---|
| A | 33 | 0.186-0.189 |
| C | 39 | 0.128-0.133 |
| B | 47 | 0.098-0.103 |
| D | — | — |
| E | 90 | 0.043-0.046 |
| F | 124 | 0.029-0.032 |
| G | 170 | 0.020-0.023 |

The manufacture of a corrugated layer having G size flutes 41 is disclosed in the applicant's '938 patent. The corrugated material blank 30 used in forming the container 20 of the present invention is preferably, though not necessarily, made of double-wall material wherein the two corrugated or fluted layers 32 and 48 are of different grades, i.e., have flutes 41 of different sizes. That is, the chordal height of the flutes 41 in first corrugated layer 32 are different from the chordal height of the flutes 41 and in the second corrugated layer 48. Additionally, the distance between the tips 38 of the flutes 41 in the first corrugated layer 32 (reference D in FIG. 5) is different from the distance between the tips 38 of the flutes 41 in the second corrugated layer 48 (reference D′). Accordingly, the tips 38 of the flutes 41 in each layer 32 and 48 are not precisely aligned, but are offset a small degree across the length of the blank 30. This configuration of the fluted layers 32 and 48 greatly reduces any heat transfer from a heated food product (not shown) located within the container, allowing the food in the container 20 to stay heated longer than in a solid or single ply structure. The reason for this is that the transfer of heat from the tip 38 of a flute 41 to the paper layer 36 which is not directly connected to the flute tip 41 allows for a longer time period required to transfer heat out of the container 20. A similar phenomenon takes place when cooking a food product held within the container 20 having a two-ply structure in a conventional oven (not shown). The longer heat transfer time creates a thermal property for the container 20 that allows the container 20 to be heated to temperatures in excess of 450° due to the length of time required to transfer heat from the flute tips 38 through the adjacent air and into the food product. These temperature transfer rates can further be manipulated by varying the flute 41 heights and spacing to accommodate different heating needs.

In the present invention, and in reference to the grade categories mentioned above, the blank 30 used in the present invention is preferably formed into a double-wall construction using one of the following flute grade combinations for the first corrugated layer 32 and the second corrugated layer 48, or vice versa: GE, GC, EB, BF, GF, CG, BG and EF. However, other combinations of flute grades for the first and second corrugated layers 32 and 48 are also encompassed within the scope of the present invention.

After the blank 30 has been formed as desired, a variety of functional coatings 54 may be placed on the blank 30. The selected coatings may be placed on the outer surfaces 50 and 52 of the blank 30 which will form the inside surface of the container 20, the outside surface of the container 20, or both. Examples of the types of coatings that can be used on the other surfaces of the blank 30 include release coatings such as an extruded polymethyl pentene sold by Mitsui of Japan under the trade name TPX DX-820 and used to provide a moisture and grease resistant barrier on the container 20, allowing food to release from the surface 50 and/or 52 after the cooking process. This particular coating also improves the heat resistance of the container 20 when in the oven to prevent scorching or burning. Other coatings such as Michelmans 2200R sold by Michelmans, Inc. of Cincinnati, Ohio or Spectracoat 763B sold by Nalco Chemical Co. of Naperville, Ill., can be applied to the surface 50 and/or 52 to provide a barrier surface coating that allows food products such as meats, cheeses and bakery to release easily from the paper without discoloring or staining the surface.

Further, underneath these various surface coatings 54, printed indicia 56 may be placed on the outer surfaces 50 and/or 52 in order to enhance brand identity or list food ingredient statements on the container 20. The printed indicia 56 can be formed of any suitable ink known in the art, and may consist of heat resistant inks and a surface coating (not shown) to prevent browning in the oven and ink rub off as is well known in the art.

During the manufacture of the blank 30, it is essential that the blank 30 have a moisture content of between 1% and 9% w/w, with 5% w/w being especially preferred. The moisture is required to be present in the blank 30 to ensure the proper forming of the blank 30 into the container in the manner to be described.

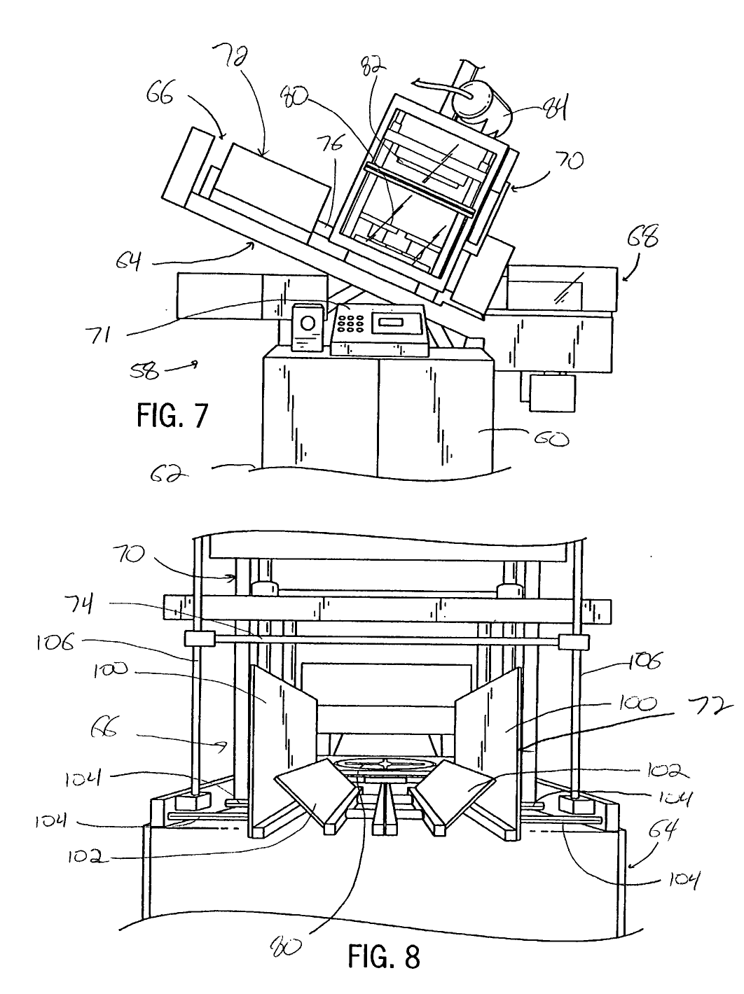

After the blank 30 is formed using the layers 32, 34, 36, 46 and 48, and the selected indicia 56 and coatings 54 have been applied to one or both of the outer surfaces 50 and 52, the blank 30 is thermoformed into the container 20 having the desired shape, such as the types illustrated in FIGS. 1 and 6. The thermoforming machine 58 used in the method of the present invention can be any conventional thermoforming machine, but is preferably the TP-26 thermoforming machine manufactured and sold by Gralex, Inc. of Lewis Center, Ohio. As best shown in FIGS. 7-11, the thermoforming machine 58 includes a base 60 that supports the machine 58 over a supporting surface 62. Opposite the supporting surface 62, the base 60 is operably connected to an inclined member 64 which includes a blank feeding mechanism 66 at one end, and a container receiving apparatus 68 opposite the feeding mechanism 66. In between the feeding mechanism 66 and receiving apparatus 68, the base 60 supports a selectively operable forming station enclosure 70 operated by a control panel 71 which serves to form each of the blanks 30 into the desired container 20.

Referring now to FIG. 8, the feeding mechanism 66 includes a loading sleeve 72 extending outwardly from one end of the inclined member 64 and dimensioned to receive a number of blanks 30. The sleeve 72 includes a pair of opposed vertical sidewalls 100 and a pair of angled, opposed bottom walls 102 positioned between the side walls 100. Each of the side walls 100 and bottom walls 102 is slidably mounted to a number of rods 104 extending between opposite sides of the inclined member 64. Thus, the sleeve 72 can be adjusted in size to accommodate blanks 30 of differing sizes, such that the thermoforming machine 58 can form containers 20 of various sizes, by moving the side walls 100 and bottom walls 102 along the rods 104. When the side walls 100 and bottom walls 102 are located in the proper positions, the sleeve 72 can be held in this configuration by a suitable locking mechanism (not shown) that engages each of the side walls 100 and bottom walls 102 to the rods 104.

The blanks 30 are stacked within the sleeve 72 such that each of the blanks 30 is oriented perpendicular to the inclined member 64. A dispensing mechanism (not shown) selectively grasps the lowermost blank 30 in the sleeve 72 and draws the blank 30 past an adjustable vertical barrier 74 which prevents the blanks 30 from merely sliding out of the sleeve 72 and onto the inclined member 64. The barrier 74 is slidably mounted to a pair of posts 106 extending upwardly and generally perpendicular to the inclined member 64, using a selectively locking mechanism (not shown) similar to that used for the side walls 100 and bottom walls 102 of the sleeve 72. The dispensing mechanism grasps the lowermost blank 30 in the sleeve 72 in any conventional manner, such as by a mechanical finger, or by a pair of suction cups which engage the blank 30, and pulls the blank 30 past the barrier 74.

Looking now at FIGS. 7, 10 and 11, after the blank 30 is past the barrier 74, the dispensing mechanism disengages from the blank 30 and allows the blank 30 to slide downwardly along the inclined member 64 under the influence of gravity into the forming station enclosure 70. The blank 30 slides along a pair of rails 76 disposed on opposite sides of the inclined member 64 in order to precisely guide the blank 30 into the forming station enclosure 70. The rails 76 are also adjustably mounted to the inclined member 64 in order to conform to the configuration of the sleeve 72. Once the blank 30 enters the forming station enclosure 70, the blank 30 contacts a pair of retractable stops 77 disposed on opposite sides of a pedestal 78 supporting a lower forming die 80. The lower die 80 includes an X-shaped central recess 79 and a circumferential recess 81, but can have any desired configuration, and is shaped to conform generally to the shape of the blank 30 and the stops 77 are positioned with respect to the lower die 80 such that, when the blank 30 contacts the stops 77, the blank 30 is positioned concentrically over the lower die 80 in the proper forming position.

In order to form the blank 30 into the container 20, the forming station enclosure 70 also includes an upper forming die 82 shaped similarly to and disposed directly above the lower forming die 80. The upper forming die 82 has a configuration complimentary to the configuration of the lower forming die 80 with a central X-shaped protrusion 83, and a circumferential protrusion 85 such that the blank 30 can be molded as necessary by the engagement of the blank 30 between the lower die 80 and upper die 82 into the container 110 as shown in FIG. 12. However, as mentioned previously, the configuration of the lower die 80 and upper die 82 can be changed into any configuration to form a container 20 having any desired shape.

When the blank 30 is positioned on the lower forming die 80, the machine 58 operates to lower the upper forming die 82 and raise the lower forming die 80 into engagement with one another. The movement of the lower die 80 and upper die 82 is accomplished by a hydraulic mechanism 84 disposed on the machine 58 on the forming station enclosure 70 opposite the base 60 and operably connected to the dies 80 and 82. The hydraulic mechanism 84 compresses the lower die 80 and upper die 82 against one another around the blank 30 at a pressure sufficient to mold the blank 30 into the shape defined by the complementary configurations of the lower die 80 and upper die 82. The pressures at which the hydraulic mechanism 84 can compress the lower die and upper die 82 in engagement with one another range from 300 psi to 2000 psi, with a preferred operating pressure of approximately 1000 psi. The forming station 70 can be designed such that the lower die 80 and upper die 82 move with respect to one another in any desired mode, such as relatively equal distances, or, in a particularly preferred embodiment, the upper die 82 traverses the majority of the distance within the forming station 70 towards the lower die 80, with the lower die 80 moving upwardly only a short distance in a manner similar to a plug assist. In a preferred embodiment, the cycle time for moving the dies 80 and 82 from the starting position to form a blank 30 and back to the starting position is between 0.5 sec. and 2.0 sec., with a particularly preferred cycle time of approximately 0.8 sec.

In order to assist the lower die 80 and upper die 82 in forming the blank 30 in direct opposition to methods of thermoforming conventional plastic materials, each of the dies 80 and 82 is also heated to a forming temperature while the blanks 30 remain at room temperature prior to forming. More specifically, the dies 80 and 82 can be heated to temperatures within the range of approximately 200° C. to about 500° C. depending upon the particular configuration and thickness of the blank 30 being formed. A preferred temperature range is approximately 250° C. to 350° C.

Because a number of the different types of blanks 30 which are to be formed within the forming station enclosure 70 of the machine 58 include a coating 54 disposed on one or both surfaces 50 and 52 of the blank 30, and preferably only the surface 50 adjacent the lower die 80, in order to prevent the damaging of the coating 54 during the forming process, the lower die 80 can be heated to a lower temperature than the upper die 82. Thus, the forming station enclosure 70 is heated sufficiently to form the blank 30 as desired in a manner that does not damage the coating 54 disposed on one surface of the blank 30. Alternatively, both of the dies 80 and 82 can be reduced in temperature from a more typical forming temperature to prevent damage to a blank 30 having a coating 54 on both surfaces 50 and 52, or the upper die 82 can be reduced in temperature to prevent damage to a coating 54 applied to the surface 52 of the blank 30 positioned adjacent the upper die 82.

In order to facilitate the temperature control and heat transfer capabilities of both the lower die 80 and upper die 82 during the forming process, each of the lower die 80 and the upper die 82 are preferably formed of a metal, such as steel, but more preferably aluminum. Further, to prevent the lower die 80 and upper die 82 from becoming prematurely worn when they are formed from aluminum, the dies 80 and 82 can be coated with a suitable wear-resistant layer (not shown) as is known in the art in order to minimize or reduce the wear on the dies 80 and 82 caused by the repeated contact with the paperboard blanks 30.

The heating of the dies 80 and 82 within the forming station enclosure 70 eases the forming process due the presence of the moisture within the paperboard blanks 30. More specifically, the amount of moisture present within the blank 30, which as described previously is preferably between 1 and 9% by weight of the blank 30, and most preferably approximately 5% by weight, enables the blank 30 to be flexed or formed more easily in order to conform to the contours of the lower die 80 and upper die 82. As the dies 80 and 82 compress the blank 30, the heat transferred from the dies 80 and 82 to the blank 30 drives out the moisture present within the blank 30 such that, after the blank 30 is formed into the desired container 20, the moisture evaporates as steam which is directed outwardly through a number of openings 86 extending through the upper die 82. The removal of the moisture further increases the rigidity of the container 20 such that the paperboard forming the container 20 maintains its shape for an even greater period of time.

The blank 30 is also formed when the dies 80 and 82 are closed by an external clamp 88 positioned on opposite sides of the die 80. The clamp 88 is open until the dies 80 and 82 contact each other and then closes to deform the periphery of the blank 30 to the shape of the exterior of the dies 80 and 82.

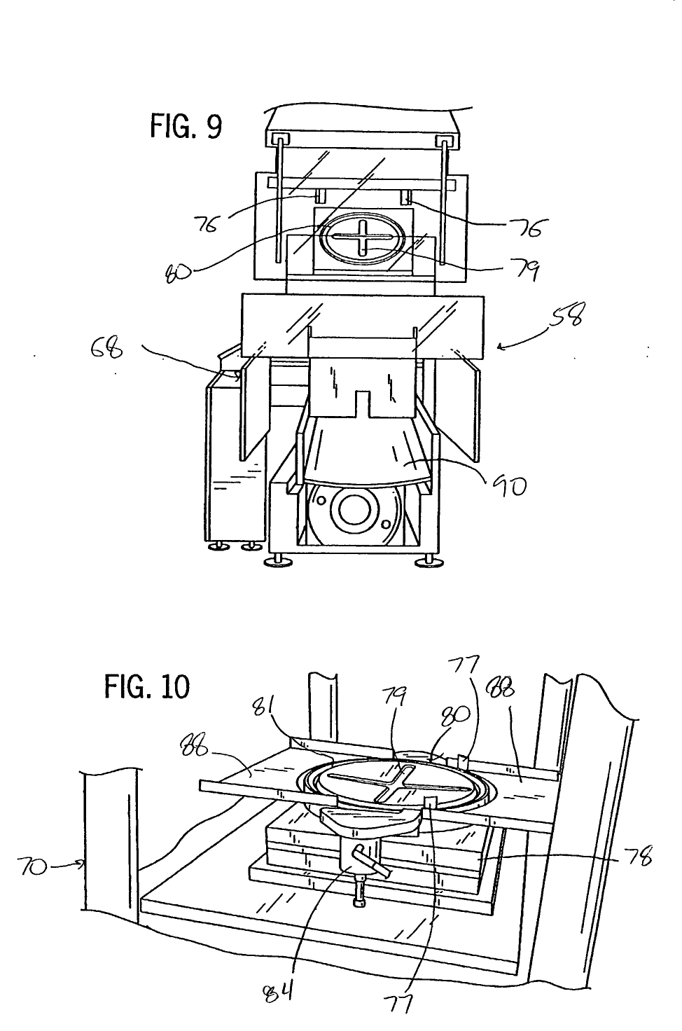

After the blank 30 has been formed by the dies 80 and 82 and clamp 88 into the container 20, the clamp 88 is opened and the upper die 82 moves away from the lower die 80 through the operation of the hydraulic mechanism 84, allowing the container 20 to be ejected from the forming station 70. The container 20 is ejected from the forming station 70 by the retraction of the stops 77 from either side of the lower die 80, and the disengagement and lowering of the external clamp 88 from around the container 20. After the stops 77 and external clamp 88 are removed, the container 20 slides under the influence of gravity along an adjustable slide 90 downwardly into the receiving or stacking apparatus 68 which is best illustrated in FIG. 9. From the receiving apparatus 68, the container 20 or stack of containers 20 can be removed and placed in a storage location for later use in packaging items on the container 20 or shipment to a separate packaging location.

In order to further assist the forming station 70 in creating the container 20 from the blanks 30, the blanks 30 may also include a number of scoring lines 92 cut into one or both surfaces 50 and 52 of the blank 30 as best shown in FIG. 13. The presence of the scoring lines 92 within the blank 30 enables the blank 30 to more easily conform to the shape of the lower die 80, upper die 82 and clamp 88 without the formation of irregular folds or creases in the resulting container 20. The scoring lines 92 can be formed on the blanks 30 prior to the insertion of the blanks 30 into the feeding mechanism 66, or by an additional station (not shown) incorporated onto the thermoforming machine 58.

Various alternatives are contemplated as being within the scope of the following claims particularly pointing out and distinctly claiming the subject matter regarded as the invention.

We hereby claim:

1. A method for thermoforming a corrugated material container, the method comprising the steps of
a) providing a thermoforming machine including a lower forming die and an upper forming die that are movable with respect to one another;
b) providing a corrugated material blank formed of a first flat layer, a first corrugated layer adhered to the first flat layer, a second flat layer adhered to the first corrugated layer opposite the first flat layer, and a second corrugated layer adhered to the second flat layer opposite the first corrugated layer;
c) heating the lower forming die and the upper forming die;
d) moving the blank between the lower forming die and the upper forming die; and
e) pressing the lower forming die and upper forming die together around the blank to form the container, wherein the blank has a moisture content of between 1% and 9% by weight of the blank.

2. The method of claim 1 wherein the first corrugated layer and the second corrugated layer have flutes of different sizes.

3. The method of claim 2 wherein the first corrugated layer is a B-fluted layer.

4. The method of claim 2 wherein the first corrugated layer is a C-fluted layer.

5. The method of claim 2 wherein the first corrugated layer is an E-fluted layer.

6. The method of claim 2 wherein the first corrugated layer is an F-fluted layer.

7. The method of claim 2 wherein the first corrugated layer is a G-fluted layer.

8. The method of claim 1 wherein the corrugated container is a tray.

9. The method of claim 1 wherein the step of heating the lower forming die and the upper forming die comprises heating the lower and upper dies to a temperature between 200° C. and 500° C.

10. The method of claim 9 wherein the lower forming die and the upper forming die are heated to different temperatures.

11. The method of claim 1 further comprising the step of forming a number of score lines in the first flat layer of the blank after providing the blank.

12. The method of claim 11 wherein the step of forming the number of score lines in the first flat layer of the blank is performed by the thermoforming machine.

13. The method of claim 1 further comprising the step of placing a coating on the first flat layer of the blank after providing the blank.

14. The method of claim 13 wherein the coating is a release coating.

15. The method of claim 13 wherein the coating is a thermoresistant coating.

16. The method of claim 1 further comprising the step of printing indicia on the first flat layer of the blank after providing the blank.

17. The method of claim 1 wherein the blank includes a third flat layer adhered to the second corrugated layer opposite the second flat layer.

18. The method of claim 17 further comprising the step of placing a coating on the third flat layer of the blank after providing the blank.

19. The method of claim 1 wherein the step of pressing the lower forming die and upper forming die together comprises pressing the dies against one another at a pressure of between 3 psi to 2000 psi.

20. The method of claim 19 wherein the step of pressing the lower forming die and upper forming die together comprises pressing the dies against one another at a pressure of about 1000 psi.

21. The method of claim 1 wherein the first and second flat layers and first and second corrugated layers are each formed from a material selected from the group consisting of:
Kraft linerboard, recycled Kraft linerboard, semi-chem paperboard, recycled machine paperboard, white top paperboard, bleached linerboard, bleached converting containerboard, bleached multiwall containerboard, bleached bag paperboard and cup stock paperboard.

22. The method of claim 1 wherein the step of pressing the lower forming die and upper forming die together removes the moisture content of the blank.

23. The method of claim 1 wherein the upper and lower dies are formed of aluminum.

24. The method of claim 1 wherein the moisture content of the blank is approximately 5% by weight of the blank.

25. A thermoformed corrugated container comprising:
a) a first flat layer;
b) a first corrugated layer adhered to the first flat layer;
c) a second flat layer adhered to the first corrugated layer; and
d) a second corrugated layer adhered to the second flat layer.

26. The container of claim 25 wherein the first corrugated layer and second corrugated layer have flutes of different sizes.

27. The container of claim 26 wherein the first corrugated layer is a G-fluted layer.

28. The container of claim 26 wherein the first corrugated layer is a F-fluted layer.

29. The container of claim 25 wherein the first flat layer includes a coating opposite the first corrugated layer.
